(19) United States
(12) Patent Application Publication
(10) Pub. No.: US 2025/0357636 A1
(43) Pub. Date: Nov. 20, 2025

(54) ELECTRODE FOR LITHIUM SECONDARY BATTERY, METHOD OF MANUFACTURING SAME, AND LITHIUM SECONDARY BATTERY INCLUDING THE SAME

(71) Applicant: SK On Co., Ltd., Seoul (KR)

(72) Inventors: Jong Chan IM, Daejeon (KR); Kyu Beom KIM, Daejeon (KR); Kyu Tae KIM, Daejeon (KR); Hyun Wook KIM, Daejeon (KR); Chae Rin RYOU, Daejeon (KR); Hyeon Su BAE, Daejeon (KR); Ye Jin YUN, Daejeon (KR)

(21) Appl. No.: 19/206,071

(22) Filed: May 13, 2025

(30) Foreign Application Priority Data
May 16, 2024 (KR) 10-2024-0063977

(51) Int. Cl. H01M 50/486; H01M 10/052; H01M 50/474; H01M 50/586

(52) U.S. Cl. CPC H01M 50/486; H01M 10/052; H01M 50/474; H01M 50/586

(57) ABSTRACT

An electrode for a lithium secondary battery includes an electrode current collector, and an electrode mixture layer and an insulating layer on at least one surface of the electrode current collector. The insulating layer includes a metal-organic framework (MOF). According to an embodiment, a lithium secondary battery with improved safety may be provided.

### CROSS-REFERENCE TO RELATED APPLICATION(S)

This patent document claims the priority and benefits of Korean Patent Application No. 10-2024-0063977 filed on May 16, 2024, the disclosure of which is incorporated herein by reference in its entirety.

### TECHNICAL FIELD

The disclosure and implementations disclosed in this patent document generally relate to an electrode for a lithium secondary battery, a method of manufacturing the same, and a lithium secondary battery including the same.

### BACKGROUND

Recently, research on electric vehicles (EVs) that may replace vehicles that use fossil fuels, such as gasoline and diesel vehicles, which are one of the main causes of air pollution, is being conducted extensively, and lithium secondary batteries with high discharge voltage and output stability are mainly used as the power source for these electric vehicles (EVs).

During the operation of the lithium secondary battery, safety issues may occur due to short circuits inside the secondary battery. This short circuit phenomenon may occur due to direct contact between the electrodes of the secondary battery, and if the short circuit continues, it may cause a fire inside the secondary battery.

Accordingly, the development of technologies that may suppress problems such as short circuits and fires inside the secondary battery is required.

### SUMMARY

The present disclosure may be implemented in some embodiments to improve the safety of a lithium secondary battery.

According to another aspect of the present disclosure, an increase in the amount of gas generated inside a lithium secondary battery may be suppressed.

According to another aspect of the present disclosure, a short circuit may be prevented from occurring inside a lithium secondary battery.

The lithium secondary battery electrode of the present disclosure, the manufacturing method thereof, and the lithium secondary battery including the same may be widely applied in green technology fields such as electric vehicles, battery charging stations, and other solar power generation and wind power generation using batteries. In addition, the lithium secondary battery electrode of the present disclosure, the manufacturing method thereof, and the lithium secondary battery including the same may be used in eco-friendly electric vehicles, hybrid vehicles, etc. to prevent climate change by suppressing air pollution and greenhouse gas emissions.

In some embodiments, an electrode for a lithium secondary battery includes an electrode current collector, an electrode mixture layer on at least one surface of the electrode current collector, and an insulating layer, wherein the insulating layer includes a metal-organic framework (MOF).

In some embodiments, the metal-organic framework (MOF) may include at least one metal selected from the group consisting of aluminum (Al), magnesium (Mg), copper (Cu), zirconium (Zr), cerium (Ce), yttrium (Y), scandium (Sc), molybdenum (Mo), titanium (Ti), vanadium (V), chromium (Cr), manganese (Mn), cobalt (Co), cadmium (Cd), calcium (Ca), palladium (Pd), platinum (Pt), gold (Au), silver (Ag), ruthenium (Ru), gadolinium (Gd), europium (Eu), terbium (Tb), zinc (Zn), iron (Fe), and nickel (Ni).

In some embodiments, the metal-organic framework (MOF) may include at least one selected from the group consisting of MOF-808, UiO-66, UiO-66-OH, CE-UiO66 (BDC), UiO66-NO₂, UiO66-NMe₂, NU-1000, PCN-777, UiO-66-NH₂, UiO-67, and UiO-68.

In some embodiments, the insulating layer may further include at least one polymer material selected from the group consisting of polyimide (PI), polyetherimide (PEI), polyamideimide (PAI), polyurethane (PU), polyethylene (PE), polypropylene (PP), polyethylene terephthalate (PET), and polyvinyl chloride (PVC).

In some embodiments, the insulating layer may further include polyetherimide (PEI).

In some embodiments, the weight ratio of the metal-organic framework (MOF) and the polymer material included in the insulating layer may be 50:50 to 99:1.

In some embodiments, the content of the polymer material included in the insulating layer may be 1 to 50 wt %.

In some embodiments, the thickness of the insulating layer may be less than or equal to the thickness of the electrode mixture layer.

In some embodiments, the electrode current collector may include an uncoated portion on which the electrode mixture layer is not disposed on a surface.

In some embodiments, the insulating layer may be disposed on the uncoated portion.

In some embodiments, the insulating layer may be disposed to cover a portion of the electrode mixture layer from a portion of the uncoated portion.

In some embodiments, the insulating layer may include a first insulating layer on the electrode current collector; and a second insulating layer on the first insulating layer.

In some embodiments, the first insulating layer may include an inorganic compound, and the second insulating layer may include a metal-organic framework (MOF).

In some embodiments, the inorganic compound may include at least one selected from the group consisting of Al₂O₃, TiO₂, MgO, CuO, MnO, CoO, CrO, Cr₂O₃, NiO, ZrO₂, CeO₂, SiO, SiO₂, GeO, GeO₂, Nb₂O₅, and B₂O₃.

In some embodiments, the second insulating layer may further include at least one polymer material selected from the group consisting of polyimide (PI), polyetherimide (PEI), polyamideimide (PAI), polyurethane (PU), polyethylene (PE), polypropylene (PP), polyethylene terephthalate (PET), and polyvinyl chloride (PVC).

In some implementations, the thickness of the first insulating layer may be less than or equal to the thickness of the second insulating layer.

In some implementations, the thickness ratio of the first insulating layer and the second insulating layer may be from 10:90 to 50:50.

In some implementations, the thickness of the first insulating layer may be from 2 μm to 10 μm.

In some implementations, the thickness of the second insulating layer may be from 10 μm to 18 μm.

In some embodiments, a method of manufacturing an electrode for a lithium secondary battery includes forming an electrode mixture layer and an insulating layer on at least one surface of an electrode current collector, wherein the insulating layer includes a metal-organic framework (MOF).

A lithium secondary battery according to one embodiment includes an electrode for a lithium secondary battery according to any one of the above-described embodiments.

### BRIEF DESCRIPTION OF DRAWINGS

Certain aspects, features, and advantages of the present disclosure are illustrated by the following detailed description with reference to the accompanying drawings.

FIG. 1A is a cross-sectional view schematically illustrating an electrode for a lithium secondary battery according to one embodiment.

FIG. 1B is a cross-sectional view schematically illustrating an electrode for a lithium secondary battery according to another embodiment.

FIG. 2A is a cross-sectional view schematically illustrating an electrode for a lithium secondary battery according to another embodiment.

FIG. 2B is a cross-sectional view schematically illustrating an electrode for a lithium secondary battery according to another embodiment.

FIG. 3 is a plan view schematically illustrating a form of the electrode for a lithium secondary battery illustrated in FIG. 2A as viewed from above.

### DETAILED DESCRIPTION

Features of the present disclosure disclosed in this patent document are described by example embodiments with reference to the accompanying drawings.

Hereinafter, the technology disclosed in this specification and the implementation examples thereof will be described in detail with reference to the attached drawings. However, the embodiment of the technology may be modified in various other forms, and the scope thereof is not limited to the implementation examples described below. In addition, the technology disclosed in this specification may be applied not only by being limited to the configurations of the implementation examples described below, but also may be configured by selectively combining all or part of each implementation example so that various modifications may be made.

As described above, development of a technology capable of suppressing a short circuit inside the lithium secondary battery is required. According to one implementation example, an insulating layer may be coated on the uncoated portion of the electrode current collector where the electrode mixture layer is not arranged, thereby preventing a short circuit between the electrodes. For example, when an insulating layer is coated on the uncoated portion of the cathode current collector, a short circuit may be prevented even if the uncoated portion comes into contact with the anode.

Meanwhile, during the operation of the lithium secondary battery, a safety issue may arise due to gas generated inside the secondary battery. The gas generated inside the secondary battery may cause a venting phenomenon in which the battery surface is opened or burst.

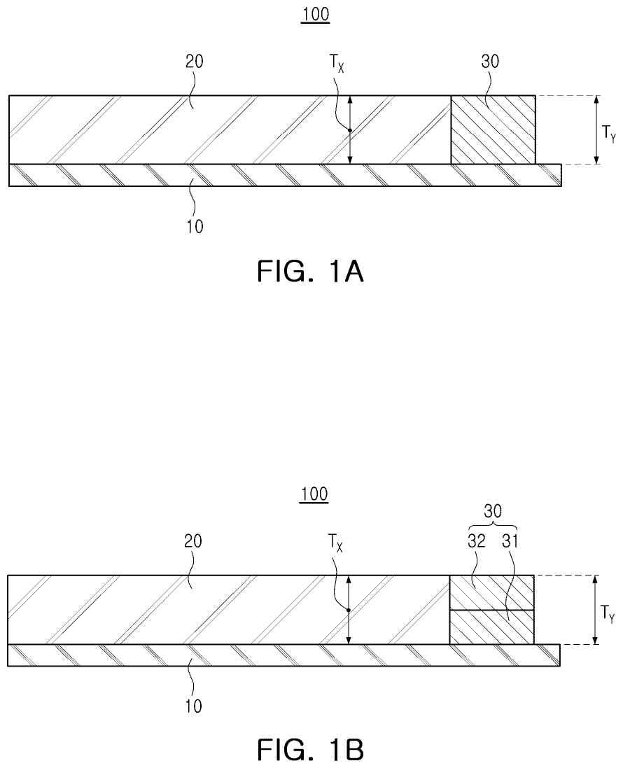

According to one embodiment, it is possible to suppress a short circuit inside a lithium secondary battery and also reduce the amount of gas generated. Hereinafter, embodiments will be specifically described with reference to FIGS. 1A to 3.

FIG. 1A is a cross-sectional view schematically illustrating an electrode for a lithium secondary battery according to one embodiment.

FIG. 1B is a cross-sectional view schematically illustrating an electrode for a lithium secondary battery according to another embodiment.

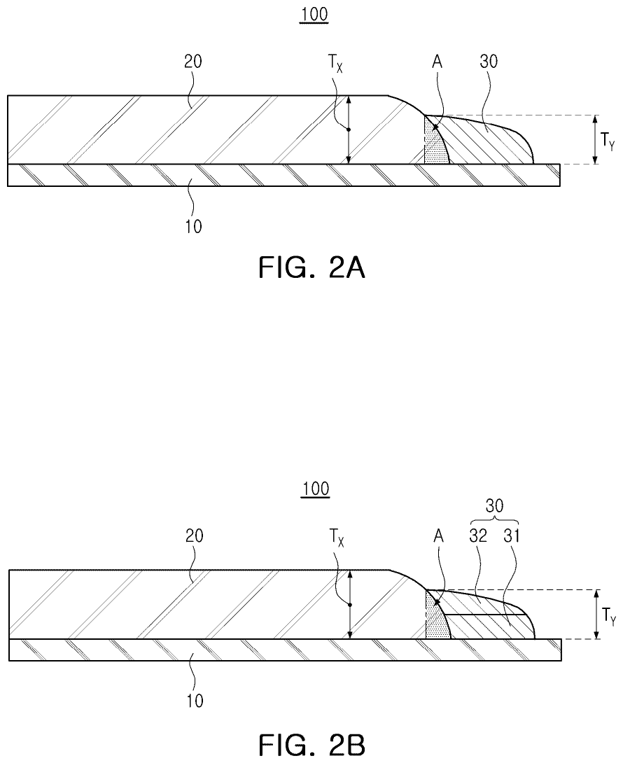

FIG. 2A is a cross-sectional view schematically illustrating an electrode for a lithium secondary battery according to another embodiment.

FIG. 2B is a cross-sectional view schematically illustrating an electrode for a lithium secondary battery according to another embodiment.

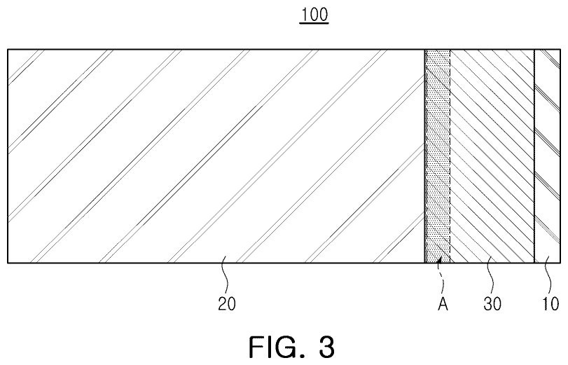

FIG. 3 is a plan view schematically illustrating a top view of the electrode for a lithium secondary battery illustrated in FIG. 2A.

### Electrode for Lithium Secondary Battery

According to one embodiment, an electrode (100) for lithium secondary battery includes an electrode current collector (10), an electrode mixture layer (20) on at least one surface of the electrode current collector, and an insulating layer (30), and the insulating layer (30) includes a metal-organic framework (MOF).

In the present specification, the metal-organic framework (MOF) refers to a porous material in which a metal ion or a metal cluster is connected to an organic ligand by a coordination bond. The metal-organic framework (MOF) included in the insulating layer (30) may excellently adsorb gases such as carbon dioxide (CO₂). Therefore, when the insulating layer (30) includes a metal-organic framework (MOF), the amount of gas generated inside the secondary battery may be reduced, and the occurrence of a battery venting phenomenon may be suppressed.

In some embodiments, the metal-organic framework (MOF) may include at least one metal selected from the group consisting of aluminum (Al), magnesium (Mg), copper (Cu), zirconium (Zr), cerium (Ce), yttrium (Y), scandium (Sc), molybdenum (Mo), titanium (Ti), vanadium (V), chromium (Cr), manganese (Mn), cobalt (Co), cadmium (Cd), calcium (Ca), palladium (Pd), platinum (Pt), gold (Au), silver (Ag), ruthenium (Ru), gadolinium (Gd), europium (Eu), terbium (Tb), zinc (Zn), iron (Fe), and nickel (Ni).

The type of the metal-organic framework (MOF) is not particularly limited. For example, the metal-organic framework (MOF) may include at least one selected from the group consisting of MOF-808, UiO-66, UiO-66-OH, CE-UiO66 (BDC), UiO66-NO₂, UiO66-NMe₂, NU-1000, PCN-777, UiO-66-NH₂, UiO-67 and UiO-68.

In some implementations, the insulating layer (30) may further include a polymer material. The polymer material is not particularly limited as long as it has insulating properties and may prevent short circuits between electrodes. For example, the insulating layer (30) may further include at least one polymer material selected from the group consisting of polyimide (PI), polyetherimide (PEI), polyamideimide (PAI), polyurethane (PU), polyethylene (PE), polypropylene (PP), polyethylene terephthalate (PET), and polyvinyl chloride (PVC).

In some embodiments, the insulating layer (30) may include a metal-organic framework (MOF) and polyetherimide (PEI). The polyetherimide (PEI) corresponds to a material having high strength and high stiffness, excellent wear resistance and stability at high temperatures, and flame retardancy. Therefore, when the insulating layer (30) includes both a metal-organic framework (MOF) and polyetherimide (PEI), deintercalation of the electrode mixture layer (20) in the area near the electrode uncoated portion and high-temperature behavior and fire of the battery may be prevented.

In some embodiments, the weight ratio of the metal-organic framework (MOF) and the polymer material included in the insulating layer may be 50:50 to 99:1. When the content of the metal-organic framework (MOF) is too high, it may be difficult to secure the insulation of the insulating layer (30). On the other hand, when the content of the polymer material is too high, the gas adsorption amount through the metal-organic framework (MOF) included in the insulating layer (30) is insufficient, making it difficult to reduce the amount of gas generated inside the battery.

In some embodiments, the content of the metal-organic framework (MOF) included in the insulating layer (30) may be 50 to 99 wt %. When the content of the metal-organic framework (MOF) included in the insulating layer (30) is less than 50 wt %, it may be difficult to improve the gas adsorption characteristics of the insulating layer (30). In addition, when the content of the polymer material included in the insulating layer (30) exceeds 99 wt %, it may be difficult to secure the insulation of the insulating layer (30).

In some embodiments, the content of the polymer material included in the insulating layer (30) may be 1 to 50 wt %. If the content of the polymer material included in the insulating layer (30) is less than 1 wt %, it may be difficult to secure the insulation of the insulating layer (30). In addition, if the content of the polymer material included in the insulating layer (30) exceeds 50 wt %, it may be difficult to improve the gas adsorption characteristics of the insulating layer (30) due to the low content of the metal-organic framework (MOF).

In some embodiments, the thickness (T_{Y}) of the insulating layer (30) may be less than or equal to the thickness (T_{X}) of the electrode mixture layer (20). If the thickness (T_{Y}) of the insulating layer (30) exceeds the thickness (T_{X}) of the electrode mixture layer (20), the thickness of the battery cell may change, causing a defect during module assembly.

In some implementations, the thickness (T_{X}) of the electrode mixture layer (20) and the thickness (T_{Y}) of the insulating layer (30) may be uniform (see FIG. 1) or non-uniform (see FIG. 2). When the thickness (T_{X}) of the electrode mixture layer (20) and the thickness (T_{Y}) of the insulating layer (30) are non-uniform, the thickness (T_{X}) of the electrode mixture layer (20) and the thickness (T_{Y}) of the insulating layer (30) may be the thickness from the surface of the electrode current collector (10) to the surface located farthest in the thickness direction of the electrode mixture layer (20) and the insulating layer (30), respectively (for example, the thickness of the thickest part of the electrode mixture layer (20) and the insulating layer (30), respectively).

In some implementations, the thickness (T_{Y}) of the insulating layer (30) may be 5 μm or more. In this case, the thickness (T_{Y}) of the insulating layer (30) may be less than or equal to the thickness (T_{X}) of the electrode mixture layer (20).

The components of the above electrode current collector (10) are not particularly limited. For example, the electrode current collector (10) may be a plate or foil made of one or more of indium (In), copper (Cu), magnesium stainless steel, titanium (Ti), iron (Fe), cobalt (Co), nickel (Ni), zinc (Zn), aluminum (Al), germanium (Ge), lithium (Li), and alloys thereof. The thickness of the electrode current collector (10) is not particularly limited. For example, the thickness of the electrode current collector (10) may be 0.1 μm to 50 μm.

When the electrode (100) for the lithium secondary battery is an anode, in some implementation examples, the electrode current collector (10) may be a copper foil (Cu-foil). When the electrode (100) for the lithium secondary battery is a cathode, in some implementation examples, the electrode current collector (10) may be aluminum foil (Al-foil).

The electrode current collector (10) may include an uncoated portion on which an electrode mixture layer (20) is not disposed on the surface. According to one implementation example, the insulating layer (30) may be disposed on the uncoated portion (see FIGS. 1A and 1B). According to another implementation example, the insulating layer (30) may be disposed to cover a portion of the electrode mixture layer (20) from a portion of the uncoated portion (see FIGS. 2A, 2B and 3). In this case, the area in which the insulating layer (30) covers a portion of the electrode mixture layer in the electrode (100) for the lithium secondary battery may be an overlap area (A).

In some implementation examples, the insulating layer (30) may include a first insulating layer (31) on the electrode current collector (10); and may include a second insulating layer (32) on the first insulating layer (see FIG. 1B and FIG. 2B). The first insulating layer (31) may be an insulating layer on the side adjacent to the electrode current collector (10) in the insulating layer (30) on at least one surface of the electrode current collector (10). In addition, the second insulating layer (32) may be disposed on the first insulating layer (31) as an insulating layer on the side spaced from the electrode current collector (10) in the insulating layer (30) on at least one surface of the electrode current collector (10).

In some implementation examples, the first insulating layer (31) may include an inorganic compound, and the second insulating layer (32) may include a metal-organic framework (MOF). In this case, the insulating layer (30) may include an inorganic compound having excellent thermal stability and a metal-organic framework (MOF) having excellent gas adsorption, so that safety may be excellent.

The first insulating layer (31) and the second insulating layer (32) may each include both a metal-organic framework (MOF) and an inorganic compound. In this case, the weight % of the inorganic compound included in the first insulating layer (31) may be equal to or greater than the weight % of the metal-organic framework (MOF), and the weight % of the metal-organic framework (MOF) included in the second insulating layer (32) may be equal to or greater than the weight % of the inorganic compound.

The second insulating layer (32) may further include a polymer material. The polymer material is not particularly limited as long as it has insulating properties and may prevent short circuits between electrodes. For example, the second insulating layer (32) may further include at least one polymer material selected from the group consisting of polyimide (PI), polyetherimide (PEI), polyamideimide (PAI), polyurethane (PU), polyethylene (PE), polypropylene (PP), polyethylene terephthalate (PET), and polyvinyl chloride (PVC).

In some embodiments, the inorganic compound may be an inorganic oxide having excellent thermal stability. For example, the inorganic compound may include at least one selected from the group consisting of Al₂O₃, TiO₂, MgO, CuO, MnO, CoO, CrO, Cr₂O₃, NiO, ZrO₂, CeO₂, SiO, SiO₂, GeO, GeO₂, Nb₂O₅, and B₂O₃.

In some embodiments, the second insulating layer (32) may include a metal-organic framework (MOF) and a polyetherimide (PEI). A detailed description of the polyetherimide (PEI) overlaps with the above-described content, and thus is omitted.

In some embodiments, the weight ratio of the metal-organic framework (MOF) and the polymer material included in the second insulating layer (32) may be 50:50 to 99:1. A detailed description of the weight ratio of the metal-organic framework (MOF) and the polymer material overlaps with the above-described content, and thus is omitted.

In some embodiments, the content of the metal-organic framework (MOF) included in the second insulating layer (32) may be 50 to 99 wt %. A detailed description of the content of the metal-organic framework (MOF) overlaps with the above-described content, and thus is omitted.

In some embodiments, the content of the polymer material included in the second insulating layer (32) may be 1 to 50 wt %. A detailed description of the content of the polymer material overlaps with the above-described content, and thus is omitted.

In some embodiments, the thickness of the first insulating layer (31) may be less than or equal to the thickness of the second insulating layer (32). For example, the thickness ratio of the first insulating layer (31) and the second insulating layer (32) may be 10:90 to 50:50. In this case, the thermal stability and insulation of the insulating layer (30) including the first insulating layer (31) and the second insulating layer (32) may be excellent.

In some implementation examples, the thickness of the first insulating layer may be 2 μm to 10 μm, and the thickness of the second insulating layer may be 10 μm to 18 μm.

The electrode mixture layer (20) may include an electrode active material. When the lithium secondary battery electrode (100) is an anode, the electrode mixture layer (20) may be an anode mixture layer including an anode active material. When the lithium secondary battery electrode (100) is a cathode, the electrode mixture layer (20) may be a cathode mixture layer including a cathode active material.

The above anode active material is not particularly limited. For example, the anode active material may be one or more selected from the group consisting of carbon-based materials such as crystalline carbon, amorphous carbon, carbon composites, and carbon fibers; lithium metal; lithium alloys; silicon-containing materials, and tin-containing materials.

The crystalline carbon may be, for example, graphite-based carbon such as natural graphite, artificial graphite, graphitized coke, mesocarbon microbead (MCMB), mesophase pitch-based carbon fiber (MPCF), etc.

The amorphous carbon may be, for example, hard carbon, soft carbon, coke, mesocarbon microbead (MCMB), or mesophase pitch-based carbon fiber (MPCF).

The element included in the lithium alloy may be, for example, aluminum, zinc, bismuth, cadmium, antimony, silicon, lead, tin, gallium, or indium.

The silicon-containing material is not particularly limited as long as it contains silicon, and may be an active material capable of being alloyed with lithium (Li). For example, the silicon-containing material may be one or more selected from the group consisting of silicon (Si), silicon oxide (SiOx; 0<x<2), metal-doped silicon oxide (SiOx; 0<x<2), carbon-coated silicon oxide (SiOx; 0<x<2), silicon-carbon composite (Si—C), and silicon alloy.

The cathode active material is not particularly limited. For example, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or a crystal structure represented by the following chemical formula 1.

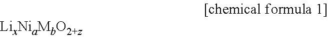

In the chemical formula 1, 0.95≤x≤1.2, 0.65≤a≤0.99, 0.01≤b≤0.4, −0.5≤z≤0.1 may be satisfied. As described above, M may include Co, Mn, and/or Al.

The chemical structure represented by the chemical formula 1 represents a bonding relationship included in the layered structure or crystal structure of the cathode active material and does not exclude other additional elements. For example, M includes Co and/or Mn, and Co and/or Mn may be provided as the main active element of the cathode active material together with Ni. The chemical formula 1 is provided to express the bonding relationship of the main active element and should be understood as encompassing the introduction and substitution of additional elements.

In some implementations, auxiliary elements may be further included in addition to the main active element to enhance the chemical stability of the cathode active material or the layered structure/crystal structure. The auxiliary elements may be incorporated together in the layered structure/crystal structure to form bonds, and in this case, it should be understood that they are also included within the chemical structure range represented by the chemical formula 1.

The auxiliary elements may include at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr, for example. The above auxiliary element may act as an auxiliary active element contributing to the capacity/output activity of the cathode active material together with Co or Mn, for example, such as Al.

For example, the cathode active material or the lithium-nickel metal oxide may include a layered structure or a crystal structure represented by the following chemical formula 1-1.

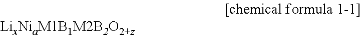

In the chemical formula 1-1, M1 may include Co, Mn, and/or Al. M2 may include the auxiliary element described above. In the chemical formula 1-1, 0.9≤x≤1.2, 0.6≤a≤0.99, 0.01≤b1+b2≤0.4, −0.5≤z≤0.1 may be satisfied.

The cathode active material may further include a coating element or a doping element. For example, elements substantially identical to or similar to the auxiliary elements described above may be used as coating elements or doping elements. For example, the above-described elements may be used alone or in combination of two or more as coating elements or doping elements.

The coating element or doping element may be present on the surface of the lithium-nickel metal oxide particle, or may penetrate through the surface of the lithium-nickel metal composite oxide particle and be included in the bonding structure represented by the chemical formula 1 or chemical formula 1-1.

The cathode active material may include a nickel-cobalt-manganese (NCM)-based lithium oxide. In this case, an NCM-based lithium oxide with an increased nickel content may be used.

The content of Ni in the NCM-based lithium oxide (for example, the mole fraction of nickel in the total moles of nickel, cobalt, and manganese) may be 0.6 or more, 0.7 or more, or 0.8 or more. In some embodiments, the Ni content may be from 0.8 to 0.95, from 0.82 to 0.95, from 0.83 to 0.95, from 0.84 to 0.95, from 0.85 to 0.95, or from 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the cathode active material may include a Mn-rich active material, an LLO (Li rich layered oxide)/OLO (Over Lithiated Oxide) active material, or a Co-less active material having a chemical structure or crystal structure represented by chemical formula 2.

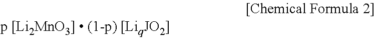

In the chemical formula 2, 0<p<1, 0.9≤q≤1.2, and J may include at least one element among Mn, Ni, Co, Fe, Cr, V, Cu, Zn, Ti, Al, Mg, and B.

The electrode mixture layer (20) may further include a binder. The binder is not particularly limited. For example, the cathode mixture layer may include one or more of polyvinylidene fluoride, styrene butadiene rubber (SBR), polytetrafluoroethylene, polyvinylidene fluoride, vinylidene fluoride/hexafluoropropylene copolymer, polyacrylonitrile, and polymethyl methacrylate as binders.

In addition, the anode mixture layer may include, as a binder, one selected from among a rubber-based binder such as styrene-butadiene rubber (SBR), fluorine-based rubber, ethylene propylene rubber, butadiene rubber, isoprene rubber, and silane-based rubber; a cellulose-based binder such as carboxymethylcellulose (CMC), hydroxypropylmethylcellulose, methylcellulose, or an alkali metal salt thereof; and a combination thereof.

The above electrode mixture layer (20) may further include a conductive material. The conductive material is not particularly limited. For example, the above-described conductive material may include one or two or more of graphite such as natural graphite or artificial graphite; carbon-based materials such as carbon black, acetylene black, Ketjen black, channel black, furnace black, lamp black, summer black, carbon fiber, carbon nanotube (CNT); metal powder or metal fiber such as copper, nickel, aluminum, silver; conductive whiskers such as zinc oxide or potassium titanate; conductive metal oxides such as titanium oxide; or conductive polymers such as polyphenylene derivatives, and the like.

The lithium secondary battery electrode (100) according to the above-described embodiments may be manufactured by the manufacturing method described below.

### Method of Manufacturing Electrode for Lithium Secondary Battery

A method for manufacturing an electrode (100) for a lithium secondary battery according to an embodiment includes an operation of forming an electrode mixture layer (20) and an insulating layer (30) on at least one surface of an electrode current collector (10), and the insulating layer (30) includes a metal-organic framework (MOF). Detailed descriptions of the electrode current collector (10), the electrode mixture layer (20), the insulating layer (30), etc. are redundant with the above-described contents, and thus are omitted.

In some embodiments, the step of forming the electrode mixture layer (20) and the insulating layer (30) on at least one surface of the electrode current collector (10) may be performed as a process of forming an electrode mixture layer (20) on at least one surface of the electrode current collector (10) and then forming an insulating layer (30).

In some embodiments, the electrode mixture layer (20) may be formed on at least one surface of the electrode current collector (10) by applying a slurry containing an electrode active material on at least one surface of the electrode current collector (10) and drying the electrode slurry at 80 to 120° C. The method of applying the electrode slurry is not particularly limited. For example, the electrode slurry may be applied to the surface of the electrode current collector (10) by a method such as bar coating, casting, or spraying.

In some embodiments, the electrode slurry may further include a solvent. The solvent is not particularly limited. For example, dimethyl sulfoxide (DMSO), isopropyl alcohol, N-methyl-2-pyrrolidone (NMP), acetone, water, etc. may be used as the solvent. The amount of the solvent used is not particularly limited as long as it is sufficient to dissolve or disperse the components and to have a viscosity that may exhibit excellent thickness uniformity when applied onto a current collector, taking into consideration the coating thickness of the slurry, manufacturing yield, etc.

In some embodiments, the insulating layer (30) may be formed on at least one surface of the electrode current collector (10) by applying an insulating coating composition to at least one surface of the electrode current collector (10) and drying the composition at 80 to 120° C. The method of applying the insulating coating composition is not particularly limited. For example, the insulating coating composition may be applied to the surface of the electrode current collector (10) by a method such as bar coating, casting, or spraying.

The insulating coating composition may include a metal-organic framework (MOF). In some embodiments, the insulating coating composition may further include a polymer material. Detailed descriptions of the metal-organic framework (MOF), polymer material, etc. overlap with the above-described contents, and thus are omitted.

The insulating coating composition may further include a solvent. The type of the solvent is not particularly limited. For example, the solvent may be N-methyl-2-pyrrolidone (NMP).

In some embodiments, the insulating layer (30) may be formed in a structure arranged on the uncoated portion of the electrode current collector (10) (see FIG. 1), or may be formed in a structure arranged to cover a portion of the electrode mixture layer from a portion of the uncoated portion (see FIGS. 2 and 3).

### Lithium Secondary Battery

A lithium secondary battery according to one embodiment includes an electrode (100) for a lithium secondary battery according to any one of the above-described embodiments. Specifically, the lithium secondary battery may include a unit cell including an electrode (100) for a lithium secondary battery according to any one of the above-described embodiments as an anode or a cathode.

In some embodiments, the unit cell may further include a separator between the cathode and the anode. The separator is not particularly limited. For example, the separator may include a porous polymer film manufactured from a polyolefin polymer such as an ethylene homopolymer, a propylene homopolymer, an ethylene/butene copolymer, an ethylene/hexene copolymer, an ethylene/methacrylate copolymer, etc. In addition, the separator may include a nonwoven fabric formed from high-melting-point glass fibers, polyethylene terephthalate fibers, etc.

In some embodiments, the lithium secondary battery may be manufactured by housing the above-described unit cell in a pouch, which is a battery case, and then injecting an electrolyte.

The electrolyte may include an organic solvent and a lithium salt. The organic solvent serves as a medium through which ions involved in the electrochemical reaction of the battery may move, and is not particularly limited. For example, the electrolyte may be a carbonate-based, ester-based, ether-based, ketone-based, alcohol-based, or aprotic solvent, used alone or in combination of two or more, and the mixing ratio in the case of using two or more in combination may be appropriately adjusted according to the desired battery performance.

The lithium salt may be a substance that is dissolved in an organic solvent and acts as a source of lithium ions in the battery, enables the basic operation of a lithium secondary battery, and promotes the movement of lithium ions between the cathode and the anode. The lithium salt is not particularly limited, and a known substance may be used at a concentration appropriate for the purpose. The electrolyte may further include a known solvent and a known additive to improve charge/discharge characteristics, flame retardancy characteristics, etc., as needed.

In some embodiments, the unit cell may not include a separator between the cathode and the anode, and may include a solid electrolyte. The solid electrolyte is not particularly limited. For example, the solid electrolyte may be an oxide-based solid electrolyte, a sulfide-based solid electrolyte, or a polymer-based solid electrolyte.

As set forth above, according to an embodiment, a lithium secondary battery with improved safety may be provided.

According to an embodiment, a venting phenomenon may be suppressed from occurring in a lithium secondary battery.

According to an embodiment, a fire may be prevented from occurring in a lithium secondary battery.

Only specific examples of implementations of certain embodiments are described. Variations, improvements and enhancements of the disclosed embodiments and other embodiments may be made based on the disclosure of this patent document.

What is claimed is:

1. An electrode for a lithium secondary battery, comprising:
an electrode current collector, and an electrode mixture layer and an insulating layer on at least one surface of the electrode current collector,
wherein the insulating layer includes a metal-organic framework (MOF).

2. The electrode of claim 1, wherein the metal-organic framework (MOF) includes at least one metal selected from the group consisting of aluminum (Al), magnesium (Mg), copper (Cu), zirconium (Zr), cerium (Ce), yttrium (Y), scandium (Sc), molybdenum (Mo), titanium (Ti), vanadium (V), chromium (Cr), manganese (Mn), (Co), cadmium (Cd), calcium (Ca), palladium (Pd), platinum (Pt), gold (Au), silver (Ag), ruthenium (Ru), gadolinium (Gd), europium (Eu), terbium (Tb), zinc (Zn), iron (Fe), and nickel (Ni).

3. The electrode of claim 1, wherein the metal-organic framework (MOF) includes at least one selected from the group consisting of MOF-808, UiO-66, UiO-66-OH, CE-UiO66 (BDC), UiO66-NO₂, UiO66-NMe₂, NU-1000, PCN-777, UiO-66-NH₂, UiO-67 and UiO-68.

4. The electrode of claim 1, wherein the insulating layer further includes at least one polymer material selected from the group consisting of polyimide (PI), polyetherimide (PEI), polyamideimide (PAI), polyurethane (PU), polyethylene (PE), polypropylene (PP), polyethylene terephthalate (PET) and polyvinyl chloride (PVC).

5. The electrode of claim 1, wherein the insulating layer further includes polyetherimide (PEI).

6. The electrode of claim 4, wherein the weight ratio of the metal-organic framework (MOF) and the polymer material included in the insulating layer is 50:50 to 99:1.

7. The electrode of claim 4, wherein the content of the polymer material included in the insulating layer is 1 to 50 wt %.

8. The electrode of claim 1, wherein the thickness of the insulating layer is less than or equal to the thickness of the electrode mixture layer.

9. The electrode of claim 1, wherein the electrode current collector includes an uncoated portion on which the electrode mixture layer is not disposed on the surface, and
the insulating layer is disposed on the uncoated portion.

10. The electrode of claim 1, wherein the electrode current collector includes an uncoated portion on which the electrode mixture layer is not disposed on the surface, and
the insulating layer is disposed to cover a portion of the electrode mixture layer from a portion of the uncoated portion.

11. The electrode of claim 1, wherein the insulating layer includes a first insulating layer on the electrode current collector; and a second insulating layer on the first insulating layer.

12. The electrode of claim 11, wherein the first insulating layer includes an inorganic compound, and
the second insulating layer includes a metal-organic framework (MOF).

13. The electrode of claim 12, wherein the inorganic compound includes at least one selected from the group consisting of Al₂O₃, TiO₂, MgO, CuO, MnO, CoO, CrO, Cr₂O₃, NiO, ZrO₂, CeO₂, SiO, SiO₂, GeO, GeO₂, Nb₂O₅, and B₂O₃.

14. The electrode of claim 12, wherein the second insulating layer includes at least one polymer material selected from the group consisting of polyimide (PI), polyetherimide (PEI), polyamideimide (PAI), polyurethane (PU), polyethylene (PE), polypropylene (PP), polyethylene terephthalate (PET) and polyvinyl chloride (PVC).

15. The electrode of claim 11, wherein the thickness of the first insulating layer is less than or equal to the thickness of the second insulating layer.

16. The electrode of claim 15, wherein the thickness ratio of the first insulating layer and the second insulating layer is 10:90 to 50:50.

17. The electrode of claim 15, wherein the thickness of the first insulating layer is 2 μm to 10 μm.

18. The electrode of claim 15, wherein the thickness of the second insulating layer is 10 μm to 18 μm.

19. A method of manufacturing an electrode for a lithium secondary battery, comprising:
forming an electrode mixture layer and an insulating layer on at least one surface of an electrode current collector,
wherein the insulating layer includes a metal-organic framework (MOF).

20. A lithium secondary battery comprising:
an electrode for a lithium secondary battery,
wherein the electrode for the lithium secondary battery includes an electrode current collector, an electrode mixture layer and an insulating layer on at least one surface of the electrode current collector, and
the insulating layer includes a metal-organic framework (MOF).
